(19) United States
(12) Patent Application Publication
(10) Pub. No.: US 2026/0213436 A1
(43) Pub. Date: Jul. 23, 2026

(54) TERMINAL BLOCK

(71) Applicant: Yazaki Corporation, Tokyo (JP)

(72) Inventors: Masatoshi YAMADA, Shizuoka (JP); Masato AKINO, Shizuoka (JP); Yasuhiro TANAKA, Shizuoka (JP); Yasuhiro OTSUTA, Shizuoka (JP); Sota ARAI, Shizuoka (JP); Yusuke TSUTAGAWA, Shizuoka (JP)

(73) Assignee: Yazaki Corporation, Tokyo (JP)

(21) Appl. No.: 19/442,325

(22) Filed: Jan. 7, 2026

(30) Foreign Application Priority Data
Jan. 22, 2025 (JP) 2025-008884

(51) Int. Cl. H01R 9/16; H01R 9/22; H01R 43/00

(52) U.S. Cl. CPC H01R 9/16; H01R 9/226; H01R 43/005

(57) ABSTRACT

A terminal block includes: a bus bar including an intermediate portion extending in a first direction, a first connection portion extending from one end of the intermediate portion along a second direction, and a second connection portion extending from the other end of the intermediate portion along the second direction toward a side opposite to an extension side of the first connection portion; a housing including an insertion hole and configured to hold the bus bar with the first connection portion inserted into the insertion hole along the second direction and in contact with the intermediate portion in the second direction; and a water stop member provided on a side of the housing opposite to a side in contact with the intermediate portion so as to surround the insertion hole, and configured to stop water between the housing and a mounting object.

### CROSS-REFERENCE TO RELATED APPLICATION(S

The present application claims priority to and incorporates by reference the entire contents of Japanese Patent Application No. 2025-008884 filed in Japan on January 22, 2025.

### BACKGROUND OF THE INVENTION

### 1. Field of the Invention

The present invention relates to a terminal block.

### 2. Description of the Related Art

As a terminal block according to the related art, for example, JP 2022 – 024667 A discloses a terminal block for relaying electrical connections between a first device and a second device. The terminal block of JP 2022 – 024667 A includes a conductive laminate having a first terminal part electrically connectable to the first device, a second terminal part electrically connectable to the second device, and an intermediate part, and is fixed to a housing with the intermediate part of the laminate covered with the housing.

However, in the terminal block, water may be stopped between the terminal block and a mounting object by a water stop member such as a packing. Such a terminal block has room for improvement in terms of watertightness between the terminal block and the mounting object.

### SUMMARY OF THE INVENTION

An object of the present invention is to provide a terminal block that can improve watertightness.

In order to achieve the above mentioned object, a terminal block according to one aspect of the present invention includes a bus bar including an intermediate portion extending in a first direction, a first connection portion extending from one end of the intermediate portion along a second direction intersecting the first direction, and a second connection portion extending from another end of the intermediate portion along the second direction toward a side opposite to an extension side of the first connection portion; a housing including an insertion hole and configured to hold the bus bar with the first connection portion inserted into the insertion hole along the second direction and in contact with the intermediate portion in the second direction; and a water stop member provided on a side of the housing opposite to a side in contact with the intermediate portion so as to surround the insertion hole, and configured to stop water between the housing and a mounting object on which the housing is mounted.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a terminal block according to an embodiment;

FIG. 2 is an exploded perspective view illustrating the terminal block according to the embodiment;

FIG. 3 is an exploded perspective view illustrating the terminal block according to the embodiment;

FIG. 4 is a perspective view illustrating the terminal block according to the embodiment;

FIG. 5 is a plan view illustrating the terminal block according to the embodiment; and

FIG. 6 is a cross-sectional view illustrating the terminal block according to the embodiment.

### DETAILED DESCRIPTION OF THE PREFERRED EMBODIMENTS

The following is a detailed description of a terminal block according to an embodiment of the present invention with reference to the drawings. Note that this invention is not limited by this embodiment. In addition, components in the following embodiment include those that can be easily assumed by those skilled in the art, or those that are substantially the same.

### Embodiment

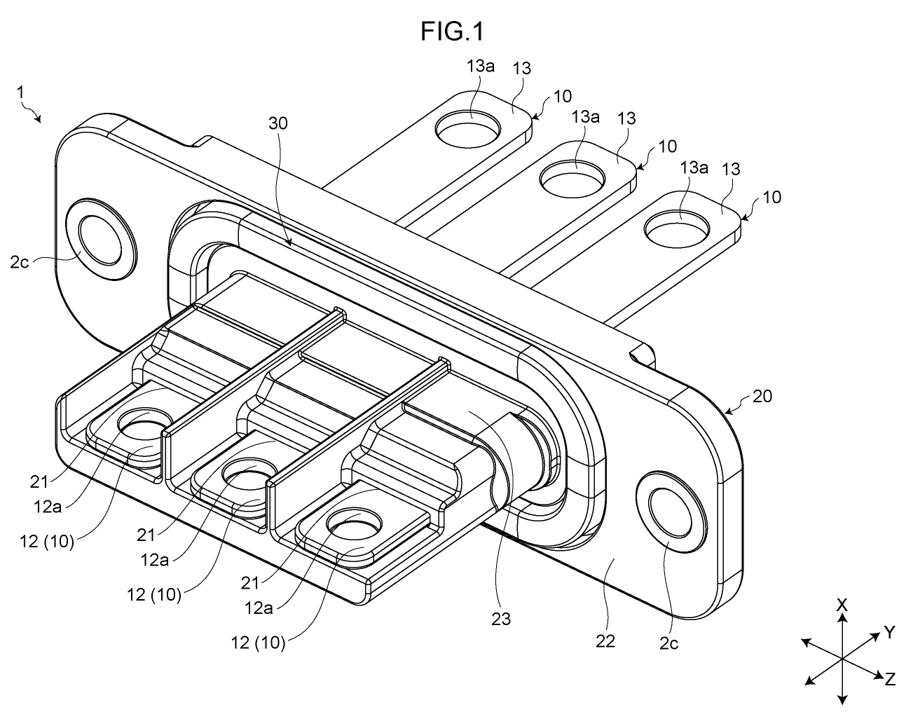

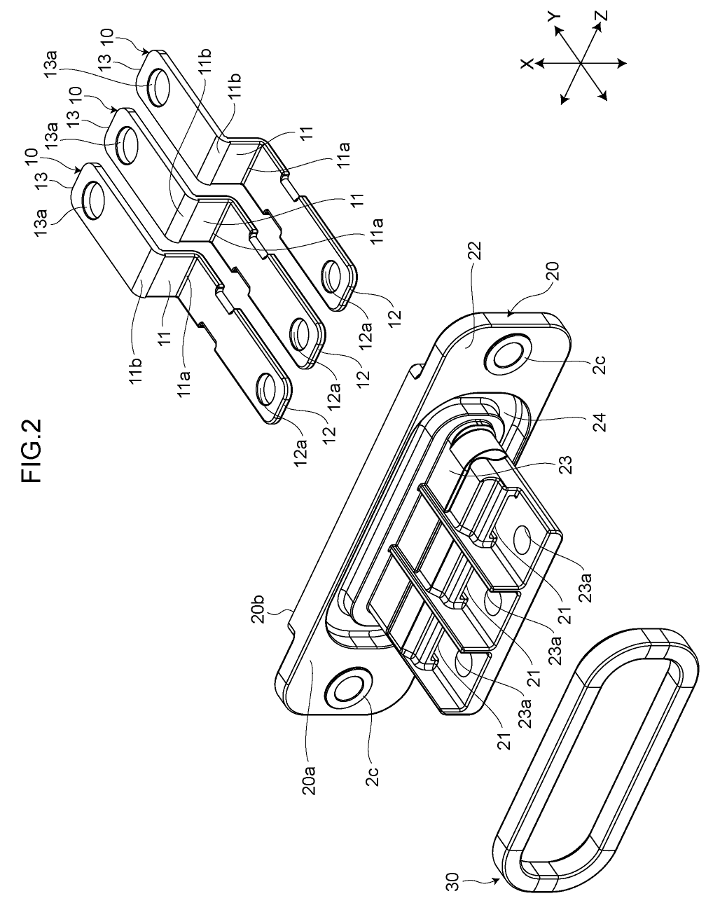

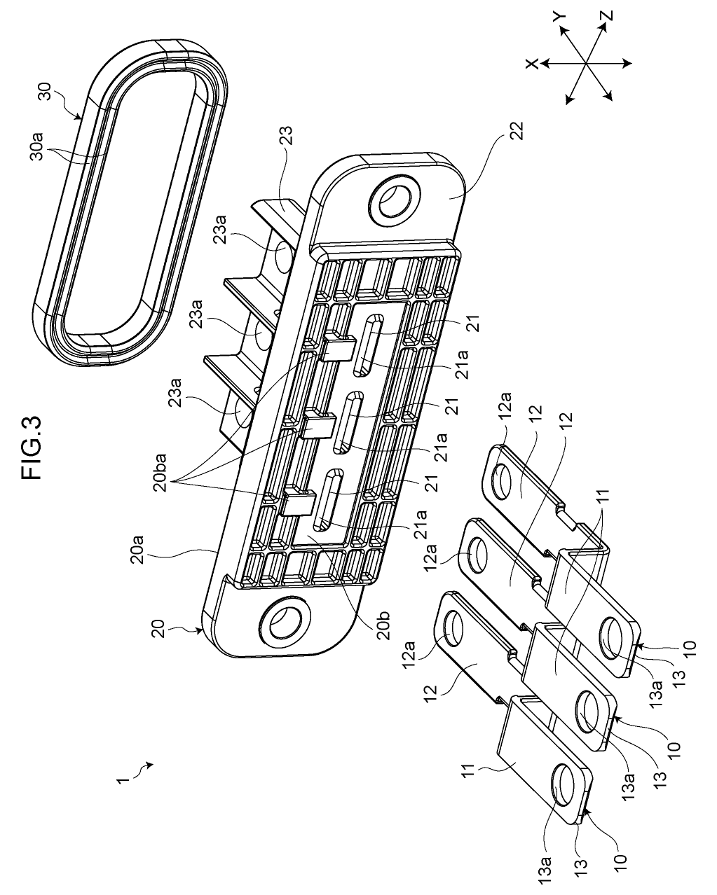

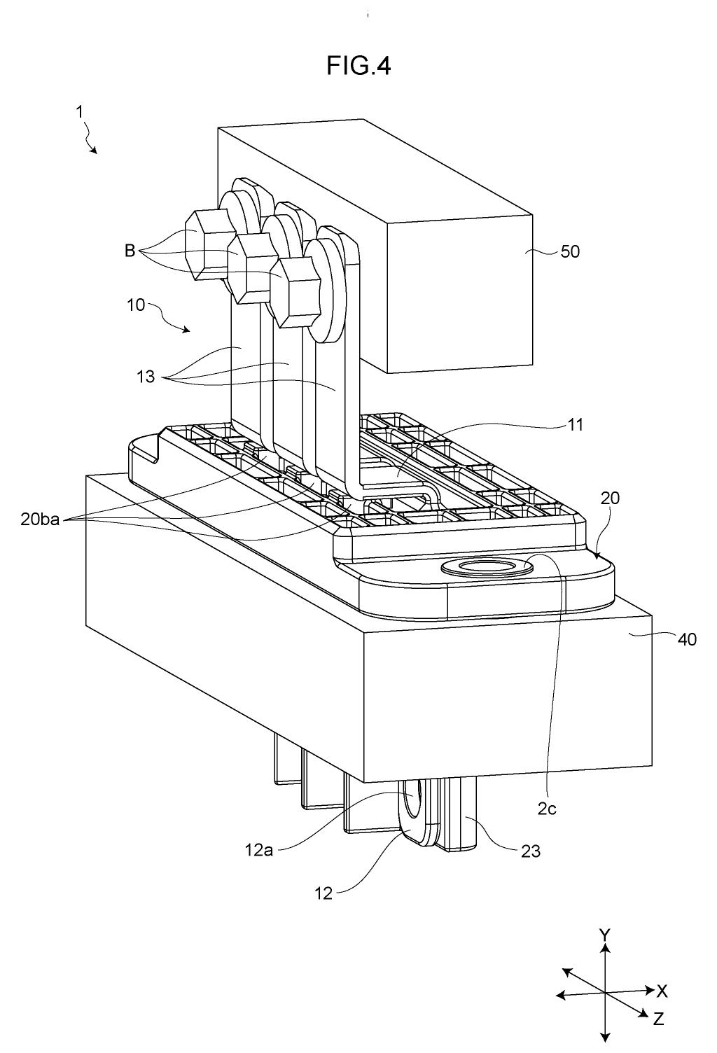

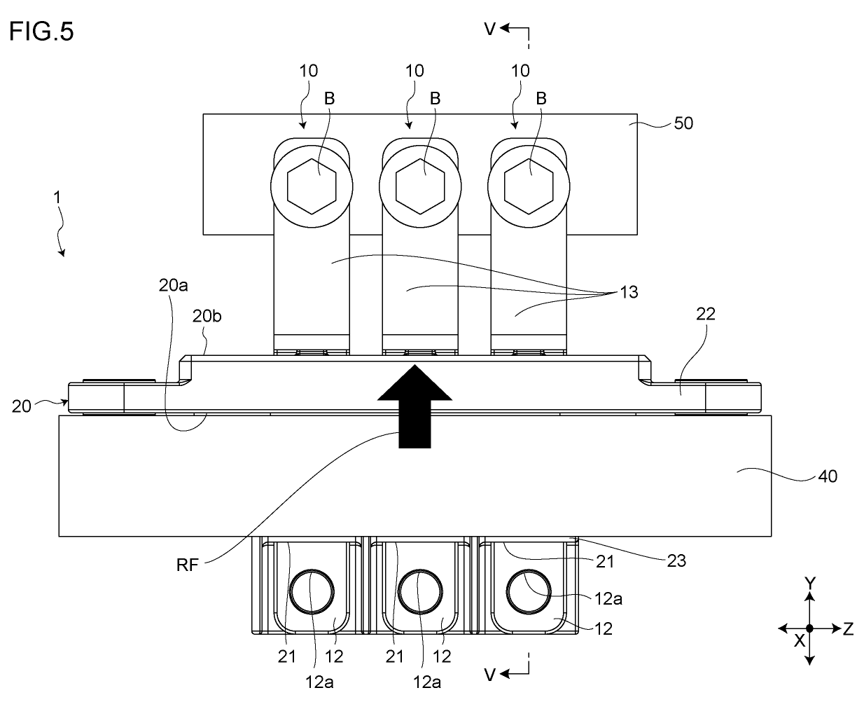

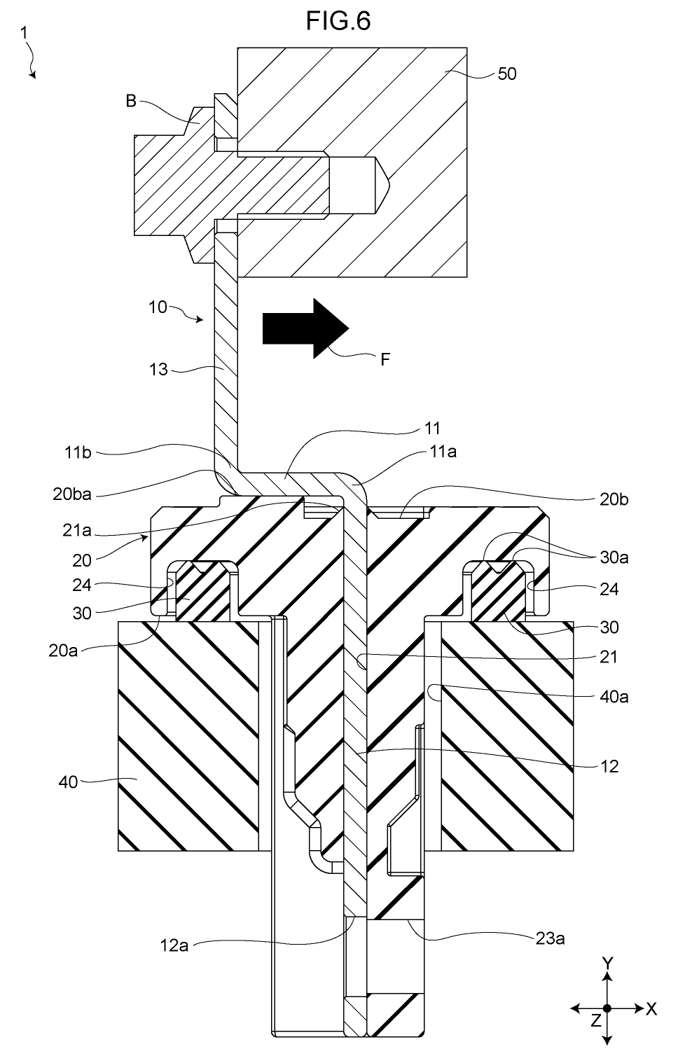

With reference to FIGS. 1 to 6, an embodiment is described. FIG. 1 is a perspective view illustrating a terminal block according to the embodiment, FIG. 2 is an exploded perspective view illustrating the terminal block according to the embodiment, FIG. 3 is an exploded perspective view illustrating the terminal block according to the embodiment, FIG. 4 is a perspective view illustrating the terminal block according to the embodiment, FIG. 5 is a plan view illustrating the terminal block according to the embodiment, and FIG. 6 is a cross-sectional view illustrating the terminal block according to the embodiment. FIG. 6 illustrates a cross-section taken along line V-V in FIG. 5.

A terminal block 1 according to the embodiment illustrated in FIG. 1 is, for example, mounted on a vehicle such as an electric vehicle or a hybrid vehicle, and relays an electrical connection between a first device and a second device. The terminal block 1 of the embodiment includes three bus bars 10, a housing 20, and a water stop member 30. The bus bar 10 electrically connects the first device to the second device. The two devices (the first device and the second device) may be a motor and an inverter mounted on a vehicle. The housing 20 is fixed to a casing (mounting object 40) of the first device (see FIGS. 4 to 6).

The bus bar 10 is formed of a metal plate having conductivity. In the embodiment, each bus bar 10 is formed in a crank shape by applying various processes such as bending to a single sheet of metal. As illustrated in FIGS. 2 and 3, each bus bar 10 has an intermediate portion 11, a first connection portion 12, and a second connection portion 13.

The intermediate portion 11 is a portion that connects the first connection portion 12 and the second connection portion 13. In this specification, the direction in which the first connection portion 12 and the second connection portion 13 are connected through the intermediate portion 11 is referred to as a first direction X, the direction of extension of the first connection portion 12 and the second connection portion 13 is referred to as a second direction Y, and the direction intersecting both the first direction X and the second direction Y is referred to as a third direction Z. In the embodiment, the first direction X, the second direction Y, and the third direction Z are mutually orthogonal. In the bus bar 10, the intermediate portion 11 is formed as a plate-shaped portion extending in the first direction X.

The first connection portion 12 is a portion that is electrically and physically connected to a connection terminal provided on the first device. As illustrated in FIG. 2, the first connection portion 12 is formed as a plate-shaped portion extending from one end in the first direction X of the intermediate portion 11 along the second direction Y. The bus bar 10 of the embodiment has a bending portion 11a between the first connection portion 12 and the intermediate portion 11, and is bent at a right angle at the bending portion 11a. A mounting hole 12a is formed at the tip of the first connection portion 12 to penetrate the first connection portion 12 in a plate thickness direction. The mounting hole 12a is a hole through which a fastening member such as a bolt is inserted to fasten the first connection portion 12 to the connection terminal of the first device.

The second connection portion 13 is a portion that is electrically and physically connected to a connection terminal 50 provided on the second device (see FIGS. 4 to 6). FIGS. 4 to 6 illustrate the connection terminal 50 having a substantially quadrangular columnar shape, but this is schematic. For example, the connection terminal 50 may be a plate-shaped bus bar provided for each bus bar 10.

As illustrated in FIG. 2, the second connection portion 13 is formed as a plate-shaped portion extending from the other end in the first direction X of the intermediate portion 11 along the second direction Y toward a side opposite to an extension side of the first connection portion 12. The bus bar 10 of the embodiment has a bending portion 11b between the second connection portion 13 and the intermediate portion 11, and at the bending portion 11b, the second connection portion 13 is bent at a right angle with respect to the intermediate portion 11, pointing toward the opposite side of the first connection portion 12. A mounting hole 13a is formed at the tip of the second connection portion 13 to penetrate the second connection portion 13 in the plate thickness direction. The mounting hole 13a is a hole through which a fastening member such as a bolt B is inserted to fasten the second connection portion 13 to the connection terminal 50 of the second device.

The housing 20 is a member that holds the bus bars 10 and is mounted on the casing (mounting object 40) of the first device (see FIGS. 4 to 6). The housing 20 is molded from, for example, an insulating synthetic resin. As illustrated in FIG. 3, the housing 20 has insertion holes 21 through the housing 20 in the second direction Y. The housing 20 is configured to hold the bus bars 10 with the first connection portion 12 inserted into the insertion hole 21 along the second direction Y and in contact with the intermediate portion 11 in the second direction Y.

The housing 20 of the embodiment has a body 22 and a support wall 23. In the housing 20, the body 22 and the support wall 23 are integrally formed with each other. The body 22 is s portion that is fixed to the mounting object 40 and has a substantially flat plate shape. Collars 2c made of metal are disposed at both ends of the body 22 in the third direction Z.

The housing 20 is fixed to the mounting object 40 by fastening members such as bolts that are inserted into the collars 2c. The mounting object 40 of the embodiment is the casing of the first device. The mounting object 40 is formed with, for example, screw holes screwed with bolts. The bolt is inserted into the collar 2c and screwed into the screw hole in the mounting object 40, thereby fixing the housing 20 to the mounting object 40.

As illustrated in FIG. 2, the support wall 23 is erected from the body 22 toward a thickness direction of the body 22. The support wall 23 protrudes along the second direction Y from a portion between the two collars 2c in the body 22. A width direction of the support wall 23 is the third direction Z, and a thickness direction of the support wall 23 is the first direction X. The shape of the support wall 23 when viewed from the first direction X is a substantially rectangle.

The insertion hole 21 is formed along the second direction Y and through the support wall 23 and the body 22. In the embodiment, the insertion holes 21 are provided in a one-to-one correspondence with the bus bars 10. That is, the housing 20 of the embodiment is formed with three insertion holes 21. In the housing 20, the insertion holes 21 are arranged side by side at intervals in the third direction Z.

The support wall 23 is formed at an opposite end of the body 22 side so that one major surface at an end of the first connection portion 12 inserted into the insertion hole 21 is exposed. The support wall 23 is formed with three through holes 23a at the opposite end of the body 22 side. Each through hole 23a is formed through the end of the support wall 23 in the first direction X. The through holes 23a are formed in a one-to-one correspondence with the insertion holes 21. That is, the three through holes 23a are formed in the support wall 23 of the embodiment. Each through hole 23a is formed at a position that communicates in the first direction X with the mounting hole 12a of the first connection portion 12 inserted into a corresponding insertion hole 21.

The through hole 23a is formed, for example, as a screw hole that can be screwed with a fastening member such as a bolt. The first connection portion 12 is electrically and physically connected to the connection terminal of the first device, for example, when a bolt is screwed into the screw hole (through hole 23a) with the bolt inserted into a mounting hole (not illustrated) formed in the connection terminal of the first device and the mounting hole 12a of the first connection portion 12.

As illustrated in FIG. 1, each bus bar 10 is held in the housing 20 by being inserted into a corresponding insertion hole 21 and through the body 22 and the support wall 23. Each bus bar 10 may be press-fitted into a corresponding insertion hole 21. The housing 20 of the embodiment holds the three bus bars 10 side by side in the third direction Z.

As illustrated in FIGS. 5 and 6, the body 22 of the housing 20 has a first surface 20a facing the mounting object 40 when the housing 20 is mounted on the mounting object 40 and a second surface 20b opposite to the first surface 20a. In the housing 20, one end of the insertion hole 21 is open to the second surface 20b of the body 22, and the other end of the insertion hole 21 is open to the end of the support wall 23. In the embodiment, an edge 21a of the insertion hole 21 protrudes against the second surface 20b around the insertion hole 21 (see FIGS. 3 and 6).

As illustrated in FIG. 3, the housing 20 has protruding portions 20ba protruding against a surrounding surface (second surface 20b) on the side in contact with the intermediate portion 11. The shape of the protruding portion 20ba when viewed from the second direction Y is substantially rectangular. The protruding portion 20ba has a flat surface facing the intermediate portion 11. As illustrated in FIGS. 4 and 6, the bus bars 10 are attached to the housing 20 such that the intermediate portions 11 are in surface contact with the protruding portions 20ba in the second direction Y. In the embodiment, the protruding portions 20ba are provided in a one-to-one correspondence with the bus bars 10. The protruding portions 20ba are disposed at intervals along the third direction Z.

In the embodiment, each protruding portion 20ba is formed at a distance in the first direction X from an opening (opening on the second surface 20b side) of the insertion hole 21 through which a corresponding bus bar 10 is inserted. That is, the protruding portion 20ba and the insertion hole 21 are disposed at intervals in the first direction X. As illustrated in FIG. 6, in the embodiment, the protruding portion 20ba is in contact with the intermediate portion 11 on the bending portion 11b side rather than the end of the bending portion 11a side in the intermediate portion 11, and is not in contact with the end of the bending portion 11b side in the intermediate portion 11. In the first direction X, a gap is formed between a base end of the first connection portion 12 and the protruding portion 20ba.

The first surface 20a of the housing 20 of the embodiment is formed with a recess 24 that holds the water stop member 30. The recess 24 is formed as a groove-shaped portion that is recessed toward the second surface 20b with respect to the surrounding surface. As illustrated in FIG. 2, the recess 24 is formed around the inner periphery of the first surface 20a to surround the support wall 23. The recess 24 is formed in a substantially oval annular shape that follows the external shape of the water stop member 30. In the housing 20, the collars 2c are located outside an area surrounded by the recess 24.

The water stop member 30 restrains liquids such as water and foreign objects from entering the inside of the terminal block 1 through a gap between the housing 20 and the mounting object 40. The water stop member 30 is formed by an elastically deformable member such as rubber or resin. The water stop member 30 of the embodiment is a packing. The water stop member 30 is provided on the side (first surface 20a side) of the housing 20 opposite to the side (second surface 20b side) in contact with the intermediate portion 11 so as to surround the insertion holes 21.

In the embodiment, the water stop member 30 is formed in a substantially oval cylindrical shape and fitted into the recess 24. As illustrated in FIG. 6, a plurality of lips 30a are provided on a surface of the water stop member 30 facing a bottom of the recess 24. The plurality of lips 30a are formed as ridged portions protruding from a body of the water stop member 30 toward the bottom of the recess 24. The plurality of lips 30a are each provided in a substantially oval annular shape along a circumferential direction of the water stop member 30 and are arranged side by side in a radial direction of the water stop member 30. The water stop member 30 of the embodiment has two lips 30a.

As illustrated in FIG. 6, the housing 20 is mounted with the support wall 23 inserted into a housing mounting hole 40a formed in the casing (the mounting object 40) of the first device. The water stop member 30 is interposed between the housing 20 and the mounting object 40 when the housing 20 is mounted on the mounting object 40.

The length of the water stop member 30 in the second direction Y is set to be longer than the depth of the recess 24 in the second direction Y. When the housing 20 is mounted on the mounting object 40 and fixed by a fastening member, the water stop member 30 is elastically deformed by being crushed between the housing 20 and the mounting object 40 and adhere closely to the recess 24 and the surface of the mounting object 40.

For example, the length of the water stop member 30 in the second direction Y is set to be longer than the depth of the recess 24 in the second direction Y before the water stop member 30 is compressed between the housing 20 and the mounting object 40, and in the state in which the water stop member 30 is compressed between the housing 20 and the mounting object 40, the length of the water stop member 30 is set to the extent that the first surface 20a of the housing 20 mounted on the mounting object 40 around the recess 24 comes in contact with the surface of the mounting object 40.

For example, the second connection portion 13 is connected to the connection terminal 50 of the second device with the housing 20 attached and fixed to the first device. At the time of connection between the second connection portion 13 and the connection terminal 50, a gap (clearance) is left between the second connection portion 13 and the connection terminal 50 to suppress mutual interference during assembly work.

The second connection portion 13 and the connection terminal 50 are connected by the bus bar 10 deforming to absorb the gap (clearance) left between the second connection portion 13 and the connection terminal 50. This connection exerts a force F on the second connection portion 13 of the bus bar 10 from the second connection portion 13 side toward the connection terminal 50 side. In the embodiment, the intermediate portion 11 of the bus bar 10 is in contact with the protruding portion 20ba of the housing 20, thereby preventing the end of the housing 20 (end opposite to the side toward which the force F is directed) from being deformed so that the end lifts up from the casing (the mounting object 40) of the first device. This configuration allows the terminal block 1 according to the embodiment to suppress a decrease in sealing pressure of the water stop member 30 caused, for example, by deformation of the housing 20 so that the housing 20 lifts up from the mounting object 40.

The housing 20 presses the water stop member 30 against the mounting object 40 side, and compresses the water stop member 30 to ensure sealing pressure, thereby increasing watertightness between the housing 20 and the mounting object 40. Due to this configuration, the housing 20 receives a reaction force RF from the water stop member 30 in the direction of lifting the housing 20 from the mounting object 40 (see FIG. 5). Since the terminal block 1 of the embodiment has the intermediate portion 11 in contact with the protruding portion 20ba of the housing 20, the deformation of the housing 20 due to the reaction force RF can also be suppressed, so that a decrease in the sealing pressure of the water stop member 30 can be suppressed.

As described above, the terminal block 1 according to the embodiment includes the bus bars 10 each including the intermediate portion 11 extending in the first direction X, the first connection portion 12 extending from one end of the intermediate portion 11 along the second direction Y intersecting the first direction X, and the second connection portion 13 extending from the other end of the intermediate portion 11 along the second direction Y toward the side opposite to the n extension side of the first connection portion 12, the housing 20 including the insertion hole 21 and configured to hold the bus bar 10 with the first connection portion 12 inserted into the insertion hole 21 along the second direction Y and in contact with the intermediate portion 11 in the second direction Y, and the water stop member 30 provided on the side of the housing 20 opposite to the side in contact with the intermediate portion 11 so as to surround the insertion hole 21, and configured to stop water between the housing 20 and the mounting object 40 on which the housing 20 is mounted.

Even when the force F toward the connection terminal 50 of the second device is applied to the second connection portion 13 or when the housing 20 receives the reaction force RF from the water stop member 30, since the intermediate portion 11 of the bus bar 10 is in contact with the housing 20, the terminal block 1 according to the embodiment can restrain the housing 20 from being deformed to be lifted from the mounting object 40 (casing of the first device). In the terminal block 1 according to the embodiment, by restraining the housing 20 from being deformed to be lifted from the mounting object 40, the amount of crushing of the water stop member 30 by the housing 20 can be restrained and the watertightness between the terminal block 1 and the mounting object 40 can be improved.

In the terminal block 1 according to the embodiment, the housing 20 has the protruding portion 20ba that protrudes against the surrounding surface 20b on the side in contact with the intermediate portion 11, and comes in contact with the intermediate portion 11.

In the terminal block 1 according to the embodiment, the housing 20 has the protruding portion 20ba, and thus the intermediate portion 11 can be easily brought into contact with the housing 20. The terminal block 1 according to the embodiment can, for example, suppress the formation of a gap between the intermediate portion 11 of the bus bar 10 and the housing 20, even when a certain degree of variation occurs in the bending shape of the bending portion 11a of the bus bar 10.

In the embodiment, the configuration in which the protruding portions 20ba are provided in a one-to-one correspondence with the bus bars 10 is described as an example; however, the embodiment is not limited thereto. For example, the housing 20 may have one protruding portion 20ba for a plurality of bus bars 10.

The number of bus bars 10 included in the terminal block 1 is not limited to three exemplified. The number of bolts B, the number of insertion holes 21, the number of through holes 23a, the number of nuts, and the like are determined according to the number of bus bars 10.

The embodiment described above is described using an example in which the through holes 23a in the support wall 23 are formed as screw holes; however, the embodiment is not limited to this configuration. For example, a recess that holds a nut or the like may be formed in the support wall 23, instead of the through holes 23a. In this case, the first connection portion 12 and the connection terminal of the first device are fastened by screwing a bolt, which is inserted into the mounting hole 12a of the first connection portion 12 and the mounting hole of the connection terminal of the first device, into a nut held in the recesses of the support wall 23.

### Reference Example

As a terminal block of a reference example different from the embodiment, a configuration in which the intermediate portion 11 and the housing 20 are not in contact with each other in the second direction Y (that is, a gap is left between the intermediate portion 11 and the housing 20) is considered. In such a configuration, the force F acting on the second connection portion 13 of the bus bar 10 from the second connection portion 13 side toward the connection terminal 50 of the second device causes the end of the housing 20 (end opposite to the side toward which the force F is directed) to lift up from the casing (the mounting object 40) of the first device, so that the sealing pressure of the water stop member 30 may be reduced.

In order to suppress a decrease in the sealing pressure of the water stop member 30 in the configuration of the reference example, for example, the size of the water stop member 30 is considered to be increased in advance to take into account the lifting of the housing 20. However, in this case, a load on the housing 20 to compress the water stop member 30 is increased, especially in the vicinity of the collar 2c fastened by the fastening member. In order to withstand this load, the housing 20 is required to have high strength and rigidity. Accordingly, the housing 20 may be larger in size and expensive materials may be required to manufacture the housing 20.

On the other hand, in the terminal block 1 of the embodiment, the intermediate portion 11 of the bus bar 10 is in contact with the housing 20, so that the housing 20 is prevented from being lifted up, thereby increasing the watertightness between the terminal block 1 and the mounting object 40 and reducing the load on the housing 20 compared to the configuration of the reference example in which a large water stop member 30 is provided.

The contents disclosed in the above embodiment can be combined and implemented as appropriate.

The terminal block according to the present embodiment is effective in improving watertightness.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a bus bar including an intermediate portion extending in a first direction, a first connection portion extending from one end of the intermediate portion along a second direction intersecting the first direction, and a second connection portion extending from another end of the intermediate portion along the second direction toward a side opposite to an extension side of the first connection portion;
a housing including an insertion hole and configured to hold the bus bar with the first connection portion inserted into the insertion hole along the second direction and in contact with the intermediate portion in the second direction; and
a water stop member provided on a side of the housing opposite to a side in contact with the intermediate portion so as to surround the insertion hole, and configured to stop water between the housing and a mounting object on which the housing is mounted.

2. The terminal block according to claim 1, wherein
the housing includes a protruding portion on a side in contact with the intermediate portion, the protruding portion protruding against a surrounding surface and being in contact with the intermediate portion.
